(19) United States
(12) Patent Application Publication
(10) Pub. No.: US 2011/0106965 A1
(43) Pub. Date: May 5, 2011

(54) APPARATUS AND METHOD FOR PEER-TO-PEER STREAMING AND METHOD OF CONFIGURING PEER-TO-PEER STREAMING SYSTEM

(75) Inventors: Woojik CHUN, Daejeon (KR); Youngroak KIM, Daejeon (KR); Dong Yul CHOI, Daejeon (KR); Seong-soo HAN, Daejeon (KR)

(73) Assignee: Electronics and Telecommunications Research Institute, Daejeon (KR)

(21) Appl. No.: 12/813,684

(22) Filed: Jun. 11, 2010

(30) Foreign Application Priority Data
Oct. 29, 2009 (KR) 10-2009-0103409

(51) Int. Cl. G06F 15/16

(52) U.S. Cl. 709/231

(57) ABSTRACT

A peer-to-peer (P2P) streaming apparatus includes a P2P logic unit positioned at a demarcation point between a private network and a public network and performing P2P communication for sharing a multimedia stream with another user; and a delivery unit delivering the multimedia stream to an internal user terminal within the private network.

### CROSS-REFERENCE TO RELATED APPLICATIONS

The present invention claims priority of Korean Patent Application No. 10-2009-0103409, filed on Oct. 29, 2009, which is incorporated herein by reference.

### FIELD OF THE INVENTION

The present invention relates to an apparatus and a method for peer-to-peer streaming and a method of configuring a peer-to-peer streaming system and, more particularly to a peer-to-peer streaming system is separated into two major components, which are a peer-to-peer engine, performing peer-to-peer communication for sharing of a multimedia stream with another user, and a viewer, performing the multimedia stream received through the peer-to-peer communication. Then, the peer-to-peer engine is implemented in a network device positioned at a demarcation point of a private network such as a home network and a public network such as Internet and, a viewer is implemented in a terminal within the private network.

### BACKGROUND OF THE INVENTION

Peer-to-peer (P2P) refers to a network communication model, different from a client-server model, in which peer nodes in an equal layer serve as a server and a client simultaneously to transmit and receive files. P2P technology is widely used to share files on Internet.

The term “streaming” refers to technology of downloading a large size multimedia file such as a music file and a moving picture file and of reproducing the same in real time. In the streaming technology, since there is no need to wait until the downloading is completed for the reproduction of the multimedia file, the streaming technology is widely used in reproduction of a music file and a moving picture file and real time broadcasting.

The P2P streaming combines the P2P model with the streaming technology and is carried out by transmitting same broadcasting to a user of another peer node while a user of any one peer node watches broadcasting streamed in real time.

FIG. 1 shows configuration of an existing P2P streaming system. The existing P2P streaming system generally includes a broadcasting server 110, a channel server 120, a tracker server 130, and peers 144 to 150. For the P2P streaming, each of the peers 144 to 150 must include a P2P streaming program of performing the P2P communication and reproducing a multimedia file received in P2P way.

The broadcasting server 110 registers a broadcasting channel of a broadcasting provider on the channel server 120 and transmits a multimedia stream 160 which is produced with a webcam or a microphone by the broadcasting provider and which is broadcasted by the broadcasting provider. On receiving registration request from broadcasting server 110, channel server 120 allocates appropriate tracker server 130 and keep the information of the multimedia stream provided by broadcasting server and tracker server. The broadcasting server 110 becomes a source of the multimedia stream 160 broadcasted in real time and due to this may be called a multimedia stream source. In view of the P2P streaming system, a user, who starts to watch any broadcasting provided by the broadcasting server 110 or the multimedia stream source, becomes a new peer 150.

The channel server 120 shows information of the multimedia stream 160 broadcasted by the broadcasting server 110 to the user of the new peer 150 and allows the user of the new peer 150 to select a desired broadcasting channel (Step 1). The user of the new peer 150 may check a list of broadcasting channels and content which may be currently provided by the channel server 120 and select a desired broadcasting channel.

The channel server 120 redirects user command of selecting a broadcasting channel from the new peer 150 to the tracker server 130 and the tracker server 130 delivers a relay list of another peer to receive a multimedia stream 160 the currently selected broadcasting channel to the user of the new peer 150 (Step 2). The relay list may include the peer 144 which directly receives and watches the broadcasting channel selected by the tracker server 130 and the user of the new peer 150 and another peers 146 and 148 which receive and watch chunk of the broadcasting channel from the peer 144 or hold the same in their buffers.

The broadcasting server 110 transmits the multimedia content, that is, the broadcasting content to the tracker server 130 in a unicast method by a chunk 165 (Step 3).

The tracker server 130 transmits the broadcasting content to some of peer 144 again. The peer 144 received the multimedia stream delivers the same to another peer 146 and the multimedia stream may be successively delivered to another peer 148. A successive transmission path 130->144->146->148 of a multimedia stream from the tracker server 130 forms a peer tree. The peer tree may be dynamically formed by the P2P engine implemented in a peer device and may be dynamically changed according to status of a network.

The user of the new peer 150 may receive the multimedia stream 160 directly from the tracker server 130 by a unit of chunk 165, or may receive and reproduce a multimedia stream of a desired broadcasting channel from another peers 144, 146, and 148 using the relay list of a peer delivered from the tracker server 130 (Step 4).

The respective peers 144 to 148 receiving the multimedia stream 160 store the multimedia stream 160 of the broadcasting channel which are currently reproduced by the peers 144 to 148 and the chunks 165 thereof in their buffers. The respective peers 144 to 148 register what multimedia streams 160 of broadcasting channels and chunks 165 thereof are held to the tracker server 130 in the form of a buffer map or a chunk list. Then, when another peer requests for broadcasting channels held by the respective peers 144 to 148, the peers 144 to 148 may transmit a corresponding chunk 165 to the peer.

However, since P2P engines performing the P2P communication for the sharing of multimedia streams with another user exist in the respective peers, the existing P2P streaming technology has the following drawbacks:

First, to perform the P2P stream, a personal computer (PC) or a set-top box (STB) executing a P2P streaming program must be always turned on (Always-On problem). Since the PC and the STB are not always turned on, overall performance of P2P may be degraded because of frequent join and leave of the peers.

Second, a private resource such as the PC and the STB is used for another user (Ownership Problem). Some of programs execute a procedure of getting agreement for using the resource when the program is installed. However, since most of users does neither read nor understand the procedure well, various problems including legal problem would be happened.

Third, since a private device is utilized in open P2P method, private information stored in a PC or an STB may be feared open (Privacy Problem). In other words, another user may leak or upload information stored in a terminal to exterior using a P2P engine of the terminal regardless of user's intent.

Fourth, data and/or programs, not intended by a user, may be feared to be stored in a private device and the data may be used as a virus or a Trojan horse for hacking (Security Problem). Another user may invade into the terminal and download data and/or programs using the P2P engine of the terminal against user's intent.

Fifth, communication bandwidth occupied by the P2P streaming program may lower communication rate of another application programs having no relation to the P2P (QoS Control Problem). This is because P2P traffic and other general traffic are not managed by a specific flow in a private circumstance connected to Internet using a network device such as a repeater, a hub, and a router. It is difficult to control traffic of network level because the P2P streaming program operates in a private terminal.

### SUMMARY OF THE INVENTION

In view of the above, the present invention solves Always-On problem, Ownership problem, Privacy problem, Security problem, and QoS control problem by implementing a P2P engine module, which is used to be installed in a private terminal, in a network device.

In accordance with a first aspect of the present invention, there is provided a peer-to-peer (P2P) streaming apparatus including: a P2P logic unit positioned at a demarcation point between a private network and a public network and performing P2P communication for sharing a multimedia stream with another user; and a delivery unit delivering the multimedia stream to an internal user terminal within the private network.

In accordance with a second aspect of the present invention, there is provided a peer-to-peer (P2P) streaming method using a network device positioned at a demarcation point between a private network and a public network, the method including: performing a P2P communication, by a P2P logic unit within the network device, for sharing a multimedia stream with another user; and delivering the multimedia stream, by a delivery unit within the network device, to an internal user terminal within the private network.

In accordance with a third aspect of the present invention, there is provided a method of constructing a peer-to-peer (P2P) streaming system using a network device positioned at a demarcation point between a private network and a public network, the method including: constructing a viewer for reproducing a multimedia stream P2P streaming programs, received through the P2P communication, in an internal user terminal within the private network with software; and constructing a P2P engine of the P2P streaming programs for performing the P2P communication for sharing a multimedia stream with another user in the network device with software or hardware.

In accordance with an embodiment of the present invention, since a P2P engine is installed in an always-turned-on network device such as a router, a gateway, and the like, the Always-on problem can be solved.

Since a network device is supplied by a P2P-based infrastructure provider or is installed by a private network operator to be shared by a plurality of users, Ownership problem caused by a specific user can be solved.

Since a multimedia player or a viewer program is installed in a private device independent from the P2P engine, a private user receives and stores only data allowed by himself or herself so that Privacy problem can be solved.

Since data for assisting an external user are not stored in a PC or an STB, the Security problem caused by the P2P can be solved.

Furthermore, since a P2P engine is integrated with a network device, the QoS control problem can be solved by a policy controlling QoS by distinguishing P2P traffics from other traffics.

### BRIEF DESCRIPTION OF THE DRAWINGS

The objects and features of the present invention will become apparent from the following description of embodiments given in conjunction with the accompanying drawings, in which:

FIG. 1 is a view illustrating an existing P2P streaming system;

FIG. 2 is a view illustrating functional blocks of an existing P2P program;

FIG. 3 is a view illustrating architecture of a P2P streaming system in accordance with an embodiment of the present invention;

FIG. 4 is a sequence chart illustrating a P2P streaming method in accordance with the embodiment of the present invention;

FIG. 5 is a block diagram illustrating a P2P streaming apparatus in accordance with the embodiment of the present invention; and

FIG. 6 is a block diagram illustrating an intern user terminal used in the P2P streaming system in accordance with the embodiment of the present invention.

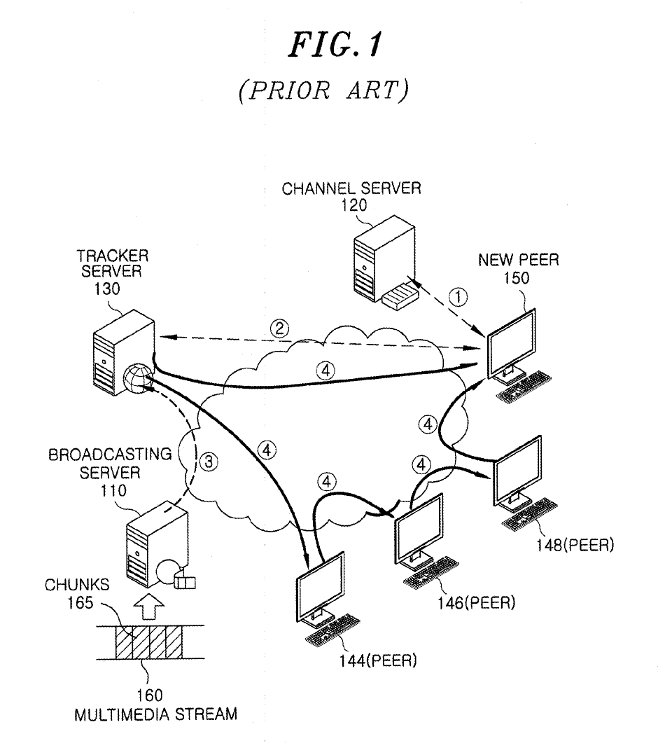

### DETAILED DESCRIPTION OF THE EMBODIMENTS

Hereinafter, embodiments of the present invention will be described in detail with reference to the accompanying drawings which form a part hereof.

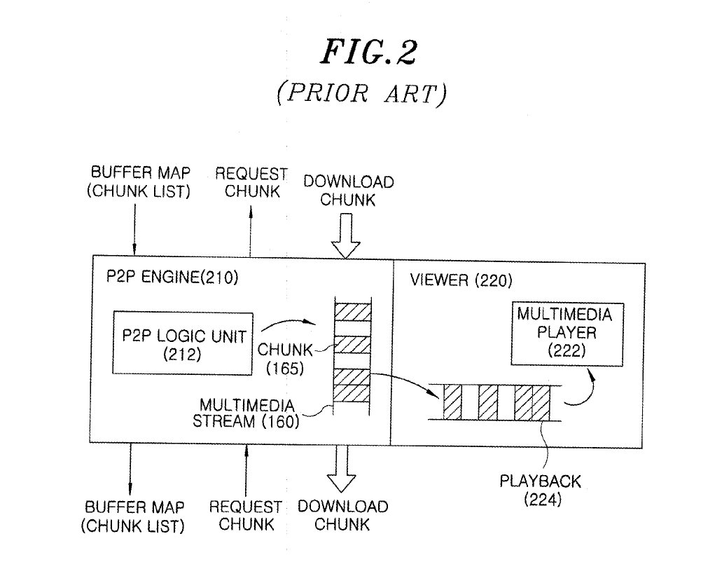

FIG. 2 is a view illustrating functional blocks of an existing P2P program. A general P2P streaming program is divided into a P2P engine 210 and a viewer 220.

The P2P engine 210 performs P2P communication for the sharing of a multimedia stream with another user. A P2P logic module 212 of the P2P engine 210 performs a series of P2P communications for downloading and uploading.

In connection with the downloading, the P2P logic module 212 may receive a request for a specific multimedia stream 160 from another peer terminal and may transmit the received multimedia stream 160 to a channel server 120 or a tracker server 130. After that, the P2P logic module 212 may receive a relay list of peers having some of the multimedia stream 160 that is a chunk 165 from the tracker server 130 and may download a desired chunk 165 from peers in the relay list. The downloaded chunk 165 is stored in a P2P buffer or a playback buffer 224 of a terminal in which the P2P streaming program is executed at least until the chunk 165 is completely reproduced.

In connection with the uploading, the P2P logic module 212 may receive a confirm request for whether having a specific chunk from the tracker server 130 and may transmit a response to the confirm request to the tracker server 130 by checking whether a corresponding chunk is stored in own buffer. A list of chunks held by a specific peer may be transmitted or received in the form of a buffer map or a chunk list. When a corresponding chunk 165 is in own buffer, the P2P logic module 212 may receive a request for transmission of the chunk 165 from another peer terminal and may upload the corresponding chunk 165 to the peer terminal which has requests for the transmission of the corresponding chunk 165.

The viewer 220 reproduces the multimedia stream received through the P2P communication. A multimedia player 222 in the viewer 220 may download and reproduce a chunk 165 which is delivered from the P2P engine 210 and is stored in the playback buffer 224 simultaneously with downloading the multimedia stream 160 to which the chunk 165 belongs.

Here, the term “chunk” refers to a file segment which is a part of the multimedia stream 160 and becomes a transmission unit of a preset size used in the P2P communication. In the field of P2P streaming, the chunk may be called by another name such as a segment, a slice, and a block.

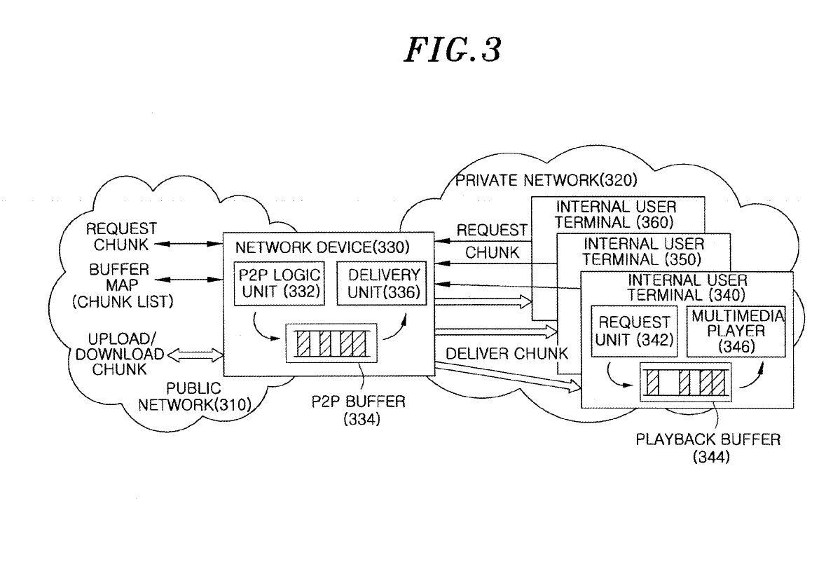

FIG. 3 is a view illustrating architecture of a P2P streaming system according to an embodiment of the present invention. In the P2P streaming system according to an embodiment of the present invention, a P2P streaming program is configured by being divided into P2P engines and viewers, such that the P2P engines 332 and 334 are implemented in a network device 330 positioned at a demarcation point or a boundary of a private network such as a home network and a public network such as Internet and the viewers 344 and 346 are implemented in internal user terminals 340, 350, and 360 within a private network 320. Here, the term “demarcation point” or “boundary” may include any one of a node included in a private network near a public network and a node included in a public network near a private network.

The network device 330 may be positioned at a demarcation point or a boundary between a public network 310 and a private network 320 and may include at least one function of a home gateway, an access router, a fire wall, an intrusion prevention system (IPS), and an IP repeater. The network device 330 may serve as a relay device in view of P2P communication with another peer.

Meanwhile, the P2P streaming apparatus according to an embodiment of the present invention may be either integrated with an existing network device 330 including the above-mentioned functions or mounted or put into the existing network device 330 in an in-line form as a separated device including a P2P logic unit 332 and a delivery unit 336 without the above-mentioned functions.

When the P2P logic unit 332 and a P2P buffer 334 of the P2P engine are integrated with the network device 330, the P2P logic unit 332 substantially performing the downloading and uploading for the chunk sharing is physically separated from the internal user terminals 340, 350, and 360 within the private network 320 and has a difficulty to access to information in the internal user terminal 340, 350, and 360. Thus, the security problem in which information received from the public network 310 through the P2P communication is stored in the private network 320 and the privacy problem in which private information in the private network 320 leaks out may be easily settled. Moreover, since the P2P logic unit 332 and a networking unit (not shown) exist together in the network device 330, the problem in which QoS of other program is not guaranteed due to the P2P streaming traffic (QoS control problem) is also easily settled.

The playback buffer 344 and the multimedia player 346 of the viewer 220 are implemented in the internal user terminals 340, 350, and 360 such as a personal computer (PC), a set-top box (STB), and the like within the private network 320. Thus, the internal user terminals 340, 350, and 360 are delivered with the multimedia stream in the unit of chunk from the P2P engine in the network device 330 only when a user of a corresponding terminal requests. By doing so, the Always-on problem in which the PC or the STB must be always turned on for the P2P communication regardless of user's watching and the Ownership problem in which private resource such as a PC or an STB is used for another user may be settled.

A P2P engine of a single network device 330 is connected to viewers of the respective internal user terminals 340, 350, and 360 within the private network 320 demarcating the network device 330 in one-to-many relationship (1:n). A single P2P logic unit 332 may assist multimedia players of a plurality of internal user terminals 340, 350, and 360.

However, due to the separation of the P2P engine from the viewer, the data transmission and reception configuration among the internal user terminals 340, 350, and 360 may be changed. In order to solve this problem, a request unit 342 of a user requesting a desired broadcasting is added to the internal user terminal 340 and a delivery unit 336 transmitting a broadcasting received through the P2P streaming to the internal user terminal 340 that has requested the broadcasting is added to the network device 330.

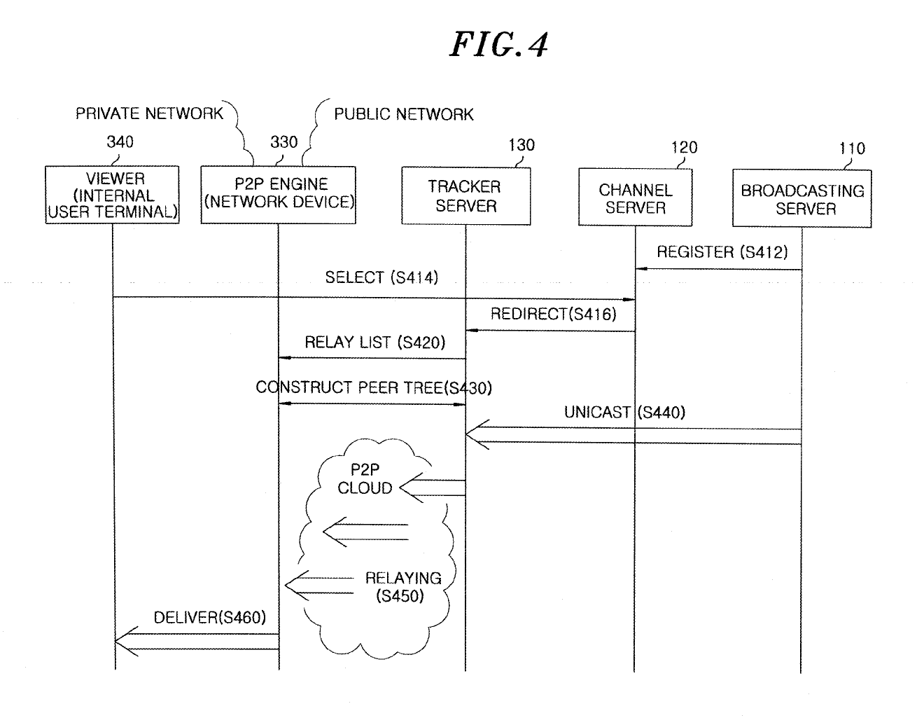

FIG. 4 is a sequence chart illustrating a P2P streaming method according to an embodiment of the present invention. The P2P streaming method according to an embodiment of the present invention is implemented by interactions among various devices such as a viewer of the internal user terminal 340, the P2P engine of the network device 330, the broadcasting server 110, the tracker server 130, and the channel server 120.

First, a broadcasting provider handling the broadcasting server 110 or a multimedia stream source registers a title and content of a currently broadcasting multimedia content to the channel server 120 provided in the form of a portal (S412). The channel server 120 is delivered with the multimedia stream in the form of unicast from the broadcasting server 110 and allocates the tracker server 130, which broadcasts the delivered multimedia stream to a plurality of peers through the P2P communication, to respective broadcasting servers 110. The broadcasting provider exists on a broadcasting viewer within a public network and the multimedia content as the broadcasting may be produced using various devices such as a webcam, a microphone, and the like and with a content authoring program. The channel server 120 properly points out the tracker server 130 and prepares to provide a corresponding broadcasting to viewers in the form of P2P streaming.

A broadcasting viewer who wants to download the broadcasting through the P2P streaming accesses to the channel server 120 using the internal user terminal 340 within a private network and selects a desired broadcasting channel (S414).

The channel server 120 redirects the broadcasting selecting command or request of the broadcasting viewer to a corresponding tracker server 130 and informs that P2P streaming of the broadcasting selected by the broadcasting viewer is started (S416).

The tracker server 130 redirected with the selecting command delivers a list of the network devices 330 which download the multimedia stream that is currently broadcasted by the tracker server 130, that is, the relay list to the network device 330 which supports the broadcasting viewer.

The network device 330 serves as a P2P streaming device or a relay device on a P2P cloud network positioned at a demarcation position between a private network and a public network. The network device 330 tries to search for connection with another peers, existing on a path within the public network from the tracker server 130 to the network device 330 in order to receive the multimedia stream of the selected broadcasting, that is, a sequential path setting toward peers in the relay list in order to determine relaying paths on a P2P cloud. During the above-procedures, a peer tree as a P2P delivery path is constructed (S430). The peer tree may be dynamically reconstructed according to state of the relay device positioned on the P2P delivery path or situation of the P2P cloud network.

When the peer tree is constructed, the broadcasting server 110 performs unicast of the multimedia stream of the selected broadcasting to an assigned tracker server 130 (S440).

The multimedia stream delivered to the tracker server 130 is relayed and delivered from the tracker server 130 to the P2P engine of the network device 330 along the peer tree on the P2P cloud within the public network (S450). In view of the P2P communication in which all of peers serve as a client, a server, and a relay simultaneously at an equal position, the relay device or the network device 330 serves as the P2P streaming device employed in the embodiment of the present invention may perform the relaying and the uploading on the P2P cloud if necessary.

The P2P engine of the network device 330 delivers the multimedia stream, received from the public network by the P2P streaming method, to the view of the internal user terminal 340 in the private network (S460). By doing so, a broadcasting viewer of the internal user terminal 340 may watch the selected broadcasting by a multimedia player of the viewer in real time.

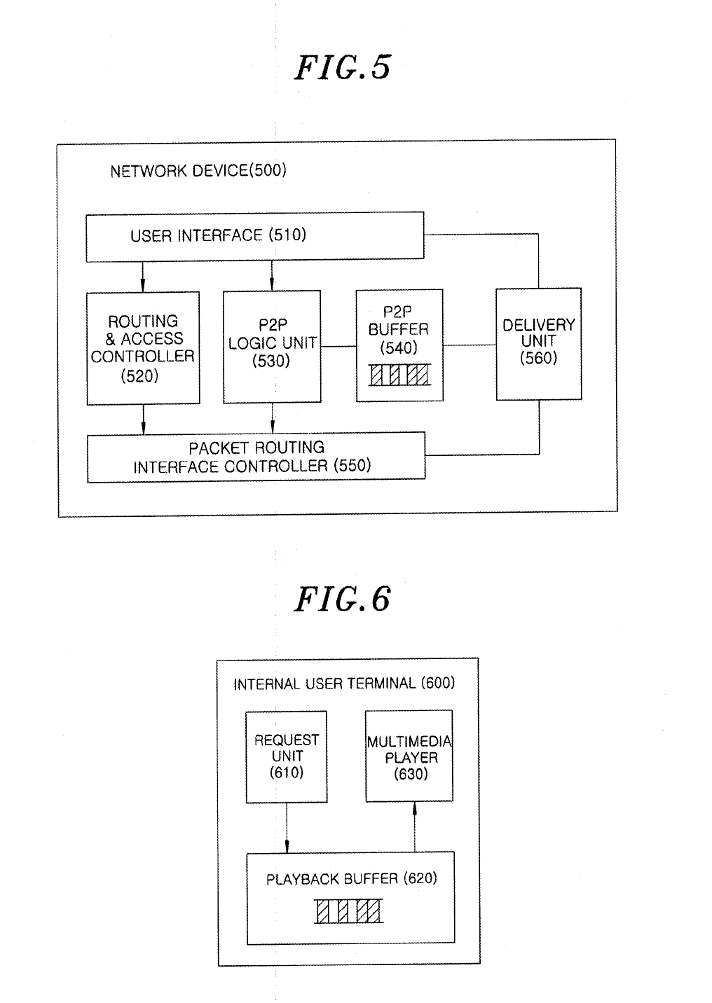

FIG. 5 is a block diagram illustrating a P2P streaming apparatus according to an embodiment of the present invention. The P2P streaming device is configured by integrating a P2P engine into a relay device or a network device 500. The network device 500 includes networking unit 510, 520, and 550 performing conventional relaying and networking, a P2P logic unit and a P2P buffer 540 performing P2P communication, and a delivery unit 336 delivering a broadcasting received through the P2P streaming to a internal user terminal 340 which has requested the broadcasting.

The networking units 510, 520, and 550 may include a user interface 510, a routing and access controller 520, and a packet forwarding interface controller 550, respectively.

The user interface 510 serves as a substantial communication interface transmitting and receiving a multimedia stream to and from another user within a private network and a public network. The user interface 510 may be implemented by a wide area network (WAN) port or a local area network (LAN) port.

The routing and access controller 520 performs a path setting and access control to another user terminal on the peer tree along the peer tree as a P2P delivery path of the corresponding multimedia. The routing and access controller 520 may delivery routing and access policy to the packer forwarding interface controller 550 in order to delivery the multimedia stream delivered from the user interface 510 to another peer on the peer tree when the network device 500 is used as a relay device relaying the multimedia stream to another peer.

The packet forwarding interface controller 550 delivers a policy about a function of transmitting/receiving and delivering a multimedia stream of a selected broadcasting from the routing and access controller 520 to the delivery unit 560. The packet forwarding interface controller 550 may perform the policy delivery even downloading, relaying, and uploading.

Due to the interactions among the functional modules 510, 520, and 550, the multimedia stream transmitted to the network device 500 is delivered to an internal user terminal within a private network or a terminal of another peer within a public network. Due to the delivery policy of the routing and access controller 520 and the packet forwarding interface controller 550, the chunk of the broadcasting requested by another peer within public network is delivered to the internal user terminal and the chunk requested by another peer within the public network is delivered to a terminal positioned at a next node on the delivery path along the peer tree held by the peer.

The P2P logic unit 530 performs P2P communication for the sharing of the multimedia stream with another user. During the downloading, the P2P logic unit 530 receives the chunk of the multimedia stream of the selected broadcasting in P2P communication through the user interface 510 and delivers the same to a user terminal selected the broadcasting through the packet routing interface controller 550 and the delivery unit 560. During the relaying and the uploading, the P2P logic unit 530 delivers the chunk of the multimedia stream in the P2P buffer 540 to a terminal at a next node on the delivery path along the peer tree held by another peer requested the chunk within the public network through the packet routing interface controller 550.

The P2P buffer 540 temporally stores the chunk of the multimedia stream received by the P2P logic unit 520 until the chunk is stored. The P2P buffer 540 may delete the chunk directly after the chunk is reproduced or may be controlled to hold the chunk even after entire multimedia stream is completely reproduced. The P2P buffer 540 may be implemented by hardware such as a memory semiconductor according to embodiments.

The delivery unit 560 delivers the multimedia stream an internal user terminal requested the multimedia stream within a private network. The delivery unit 560 may prevent the multimedia stream received by the P2P logic unit 530 to be delivered to a user that did not request the multimedia stream. The delivery unit 560 may deliver a specific chunk to a playback buffer unit 620 of an internal user terminal requested the specific chunk.

FIG. 6 is a block diagram illustrating an intern user terminal used in the P2P streaming system according to the embodiment of the present invention. An internal user terminal 600 includes a request unit 610, a playback buffer 620, and a multimedia player 630.

The request unit 610 requests the network device 500 to download a multimedia stream of a broadcasting channel requested by a broadcasting viewer.

The playback buffer 620 temporally stores a chunk of the broadcasting requested by the request unit 610 and received from the delivery unit 560 of the network device 500. The playback buffer 620 provides a temporal storage required for a client program or the multimedia player 630 to reproduce the broadcasting selected by a viewer.

The multimedia player 630 reproduces the chunk of the broadcasting temporally stored in the playback buffer 620 in the form of music or a moving picture. According to embodiment of the present invention, the multimedia player 630 may be implemented by software installed in the internal user terminal 600.

The above-mentioned modules, the functional blocks, and the devices employed in the embodiments of the present invention may be implemented by various known devices such as an electronic circuit, an IC, an application specific integrated circuit (ASIC), and the like, in the form of an individual device or a combination of two of the same.

While the invention has been shown and described with respect to the embodiments, it will be understood by those skilled in the art that various changes and modification, such as a picture and an image that may be displayed by a display such as an LCD instead of characters, may be made without departing from the scope of the invention as defined in the following claims.

What is claimed is:

1. A peer-to-peer (P2P) streaming apparatus comprising:
a P2P logic unit positioned at a demarcation point between a private network and a public network and performing P2P communication for sharing a multimedia stream with another user; and
a delivery unit delivering the multimedia stream to an internal user terminal within the private network.

2. The P2P streaming apparatus of claim 1, wherein the P2P logic unit
candidates, delivers a request for a first specific multimedia stream received from the internal user terminal to a channel server or a tracker server;
receives a relay list of users having a first chunk as a part of the first multimedia stream from the tracker server; and
receives the first chunk from a user listed in the relay list.

3. The P2P streaming apparatus of claim 2, wherein the P2P logic unit forms a peer tree as a P2P delivery path of the first chunk using the relay list and receives the first chunk through a user terminal on the peer tree.

4. The P2P streaming apparatus of claim 2, further comprising a P2P buffer temporally storing the first chunk until the first chunk is delivered to the delivery unit.

5. The P2P streaming apparatus of claim 4, wherein the delivery unit
receives a confirm request for whether a second chunk as a part of a second specific multimedia stream is held from the tracker server;
transmits a response for whether the second chunk is held by checking the P2P buffer;
receives a transmission request for the second chunk from an external user terminal within the public network; and
transmits the second chunk to the external user terminal when the second chunk exists in the P2P buffer.

6. The P2P streaming apparatus of claim 2, wherein the delivery unit delivers the first chunk to the internal user terminal requested the first multimedia stream.

7. The P2P streaming apparatus of claim 1, wherein the demarcation point comprises at least one of nodes included in the private network near the public network and nodes included in the public network near the private network.

8. The P2P streaming apparatus of claim 1, wherein the P2P logic unit distinguishes traffic of the P2P communication from traffic of other communication and manages QoS.

9. The P2P streaming apparatus of claim 1, further comprising a networking unit includes at least one function of a hone gateway, an access router, a fire wall, an intrusion prevention system (IPS), and an IP repeater.

10. The P2P streaming apparatus of claim 9, wherein the networking unit comprises:
a user interface transmitting and receiving the multimedia stream to and from another user;
a routing and access controller performing a path setting and an access control toward another user terminal on a peer tree as a P2P delivery path of the multimedia stream along the peer tree; and
a packet forwarding interface controller transmitting the multimedia stream to the routing and access controller and receiving or delivering the multimedia stream from the routing and access controller to the delivery unit.

11. The P2P streaming apparatus of claim 1, connected to a plurality of internal user terminals in one-to-many (1:n) relationship.

12. The P2P streaming apparatus of claim 1, wherein another user comprises at least one of a tracker server transmitting the multimedia stream and at least one of external user terminals within the public network.

13. A peer-to-peer (P2P) streaming method using a network device positioned at a demarcation point between a private network and a public network, the method comprising:
performing a P2P communication, by a P2P logic unit within the network device, for sharing a multimedia stream with another user; and
delivering the multimedia stream, by a delivery unit within the network device, to an internal user terminal within the private network.

14. The P2P streaming method of claim 13, wherein the performance of the P2P communication comprises:
delivering a request for a first specific multimedia stream received from the internal user terminal, by the P2P logic unit, to a channel server or a tracker server;
receiving a relay list of users holding the first chunk as a part of the first multimedia stream, by the P2P logic unit, from the channel server or the tracker server; and
receiving the first chunk, by the P2P logic unit, from a user within the relay list.

15. The P2P streaming method of claim 14, further comprising constructing a peer tree as a P2P delivery path of the first chunk, by the P2P logic unit, using the relay list and receiving the first chunk through a user terminal on the peer tree.

16. The P2P streaming method of claim 14, wherein the delivery unit delivers the first chunk to the internal user terminal requested the first multimedia stream.

17. The P2P streaming method of claim 14, wherein the performance of the P2P communication comprises:
receiving a confirm request for whether a second chunk as a part of a second specific multimedia stream, by the P2P logic unit, from a channel server or a tracker server;
transmitting a response to whether the second chunk is held, by the P2P logic unit, by checking the P2P buffer;
receiving, by the P2P logic unit, a transmission request for the second chunk from an external user terminal within the public network; and
transmitting, by the P2P logic unit, the second chunk to the external user terminal when the second chunk exists in the P2P buffer.

18. The P2P streaming method of claim 13, further comprising:
transmitting and receiving, by a user interface of the network device, the multimedia stream to and from another user;
performing a path setting and an access control, by a routing and access controller of the network device, between another user terminal on a peer tree as a P2P delivery path of the multimedia stream along the peer tree; and
delivering, by a packet forwarding interface controller of the network device, policy of transmission/reception or delivery of the multimedia stream from the routing and access controller to the delivery unit.

19. A method of constructing a peer-to-peer (P2P) streaming system using a network device positioned at a demarcation point between a private network and a public network, the method comprising:
constructing a viewer for reproducing a multimedia stream P2P streaming programs, received through the P2P communication, in an internal user terminal within the private network with software; and
constructing a P2P engine of the P2P streaming programs for performing the P2P communication for sharing a multimedia stream with another user in the network device with software or hardware.

20. The method of claim 19, wherein the P2P engine delivers a request for a specific multimedia stream received from the internal user terminal to a channel server or a tracker server; receives a relay list of users holding a chunk of the requested multimedia stream from the channel server or the tracker server; receives the chunk from a user in the relay list; and delivers the received chunk the internal user terminal requested the specific multimedia stream.
